(19) United States
(12) Patent Application Publication
(10) Pub. No.: US 2011/0250440 A1
(43) Pub. Date: Oct. 13, 2011

(54) PHOSPHATE CEMENT COMPOSITIONS USING ORGANIC SOLVENT RETARDERS

(76) Inventor: David Goodson, (US)

(21) Appl. No.: 13/082,023

(22) Filed: Apr. 7, 2011

Related U.S. Application Data
(60) Provisional application No. 61/322,047, filed on Apr. 8, 2010.

(51) Int. Cl. B32B 5/00; C04B 12/02

(52) U.S. Cl. 428/332; 106/690; 106/691

(57) ABSTRACT

A method of producing a slow-setting, workable aqueous phosphate cement mixture, including providing a first cementitious constituent, providing a second cementitious constituent adapted to combine with the first cementitious constituent to produce an aqueous phosphate cement mixture, providing a volatile organic retardant, and mixing the first cementitious constituent, the second cementitious constituent, and the volatile organic retardant to yield a slow-setting phosphate cement mixture. The volatile organic retardant may be selected from the group including acetone, ethanol, methanol, and isopropanol.

### CROSS-REFERENCE TO RELATED APPLICATIONS

This application claims priority to co-pending U.S. Provisional Patent Application Ser. No. 61/322,047, filed on Apr. 8, 2010.

### TECHNICAL FIELD

The present invention relates generally to ceramic materials and, more particularly, to sprayable phosphate cement coatings and a novel method and apparatus for producing them.

### BACKGROUND

Ceramic cements are mixtures of water and reactive metal oxides that harden and fasten upon setting. Cements have a variety of familiar uses, such as the adhesive component to concrete (essentially an agglomeration of rocks held together by cement), the bonding layer that holds bricks together to form walls, as structural building materials such as patio or garage slabs. The cement of choice for most of these familiar uses is Portland cement, a mixture of water and calcined lime and silica. Upon curing, the primary constituents of Portland cement are dicalcium silicate and tri-calcium silicate phases. Portland cement has the advantage of being cheap to produce and relatively easy to mix and pour. Part of the reason Portland cement is so cheap is because the silica component may come from a wide variety of sources, usually silica-containing clays, and also because these clays do not have to be especially pure or consistent.

Portland cement also suffers from some disadvantages, inconsistency of physical properties arising from the inherent inconsistency of the source materials (both in composition and quality) being chief among them. Portland cements also have the disadvantage of having a relatively high viscosity. While they are well adapted to pouring and spreading, Portland cements are not well suited for pumping and spraying. Moreover, Portland cements are characterized by a relatively slow curing time. Another disadvantage of Portland cement is that it does not bond well to itself, especially if the existing cement surface is already hardened. Portland cement-containing structures, such as cement driveways or road segments, must be formed in essentially one step. If there is an interruption in the forming of a Portland cement body sufficient to allow the cement to begin to cure, a structural discontinuity or “cold joint” can result. Moreover, Portland cement cannot be used to patch a Portland cement structure absent costly and time consuming surface pre-treatment at the patch interface. While Portland cement is usually applied by pouring from a mixer or by spreading from a palette, it can also be sprayed. Sprayed Portland cement, or “shotcrete”, is applied as a thick, rough layer of cement only in industrial applications that do not necessitate even or controlled coating, such as “shotcreting” over wire mesh for producing the foundations of swimming pools and for walls of tunnels and mines. Shotcrete is applied in very thick rough coats through enormous and expensive pneumatic sprayers and pumps that are not suited for smaller scale applications. Shotcrete sprayers cannot produce thin coatings or smooth finishes, and shotcreted surfaces sacrifice aesthetics for functionality. Portland cements set up and harden very slowly and are fairly porous, especially to road salt, which can degrade and rust steel reinforcement members in the concrete, causing expansion of the reinforcement members and the eventual rupture of the cement from within.

Another kind of cement is phosphate cement. Phosphate cements undergo an acid-base reaction during curing. Typically, the acid component is either phosphoric acid (usually in liquid form) or an alkali-earth phosphate salt such as magnesium phosphate, calcium phosphate or ammonium phosphate. The base component is typically dead burned magnesium oxide. The compositions of the acid and base pair are chosen such that the resulting combination will react to form a cementitious metal-phosphate. The acid and base components when mixed rapidly cure to form a cementitious metal phosphate phase. The phosphate cement forms by a highly exothermic reaction and sets up rapidly, quickly agglomerating and increasing in viscosity.

Most phosphate cements have excellent strength and hardness characteristics, and have the additional advantage of adhering to most other materials, including cement (both phosphate and Portland), brick, metal, wood, most wood products, insulation, asphalt, roofing materials, membranes and some glasses. Phosphate cements also have excellent chemical stability and compressive strength, and have toughness characteristics superior to those of Portland cement. Moreover, phosphate cements tend to set up with little or no open porosity and therefore can be used to form waterproof forms and seals. Phosphate cements, like most ceramics, are fireproof and tend to be electrically nonconductive and good thermal and acoustic insulators.

Traditionally, phosphate cements have been used almost exclusively for dental and biological applications, road patching, and specialized refractory applications. This is because phosphate cements are roughly an order of magnitude more expensive than Portland cement and cannot be used in bulk because the highly exothermic nature of the phosphate reaction causes phosphate cements to set up rapidly and to agglomerate, while generating a lot of heat. Unlike in Portland cement, where the heat of hydration evolves slowly and plateaus, the heat of hydration of phosphate cements spikes quickly, with great heat evolution occurring promptly after the cement is mixed. This results in the phosphate cement setting up too quickly to be workable. There are a variety of coating applications (fireproofing, water and fluid sealants, electrical insulation foam, electrical insulation coatings, thermal insulation coatings, chemical insulation coatings, rust proofing, overcoating existing roofs, walls, drywall, siding, floors, basements, roads and the like) that could be addressed by a thin or thick ceramic coating of a material having the properties of phosphate cement, but currently the technology does not exist to commercially apply thin cement coatings and, more particularly, to spray phosphate cements coatings. While the superior properties of phosphate cements would make them desirable for a much wider range of applications, their reactivity makes them ill-suited for bulk mixing, dipping, brushing, rolling and spraying since they tend to thicken and agglomerate quickly, rapidly clogging and packing spray nozzles, needle valves, hoses, and containers. This makes phosphate cements impractical for spraying, especially since most commercial spray apparati have orifices and conduits too small to accommodate the flow of a liquid having the density and viscosity of a phosphate cement. Further, most commercial spray apparati are expensive, and would be ruined by phosphate cements setting up in their hoses, nozzles, and containers, making their usage with phosphate cements impractical. Moreover, since ejecting the phosphate cement is the primary method of dissipating the excess waste heat generated by the acid-base reaction, a clogged spray line or nozzle can contribute to the overheating of the sprayer system, therefore increasing the hazard of fire or an explosion of the closed container. Further, overheating of the cement mixture in the sprayer also increases the reaction rate, thereby evolving even more heat and potentially causing further agglomeration in the spray gun and hoses resulting in a catastrophic runaway reaction.

There are currently no known cements capable of being applied as a thin, sprayed on coating or layer. There are also currently no known phosphate cement compositions that may be applied to a substrate by conventional spraying, coating, dipping or brushing techniques. There is therefore a need for a phosphate cement material with a controllably slow reaction and curing rate that can be mixed in bulk with a stable, low viscosity suitable for application as a thin coating via sprayer or via conventional application techniques. The present invention addresses this need.

### SUMMARY

One form of the present invention relates to a phosphate cement composition with a sufficiently controlled reaction rate that the phosphate cement may be mixed in bulk and with suitable viscosity to be sprayed, poured, and/or placed in bulk. Another form of the present invention relates to a method for mixing and spray applying a phosphate cement composition onto a metallic substrate.

One object of the present invention is to provide an improved cement. Related objects and advantages will be apparent from the following description.

### BRIEF DESCRIPTION OF THE DRAWINGS

FIG. 1 is a perspective view of a commercial embodiment of a prior art spray gun apparatus.

FIG. 2 is a first perspective view of four different phosphate cement spray coatings on a concrete floor.

FIG. 3 is an enlarged perspective view of two of the phosphate coatings of FIG. 2.

FIG. 4 is a perspective view of a sprayed-on phosphate cement coating partially covering a brick and mortar wall.

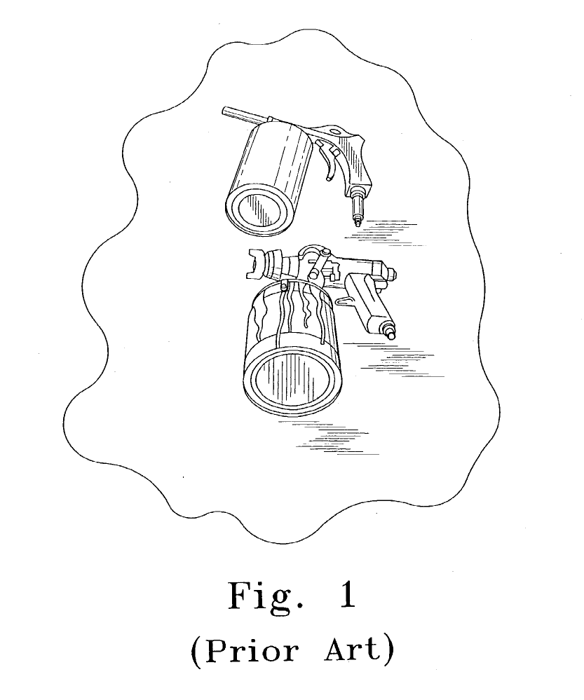

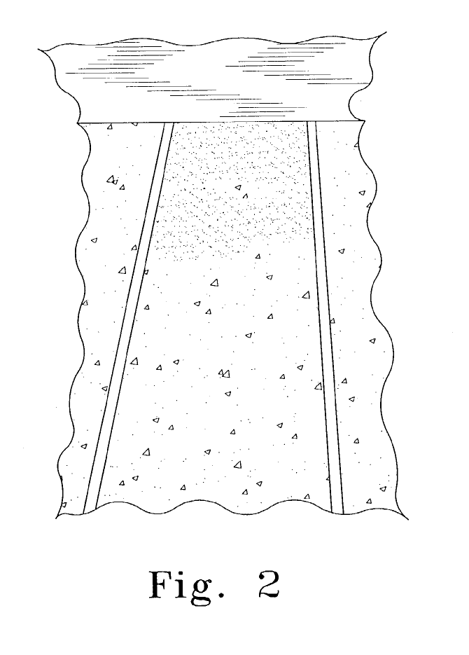

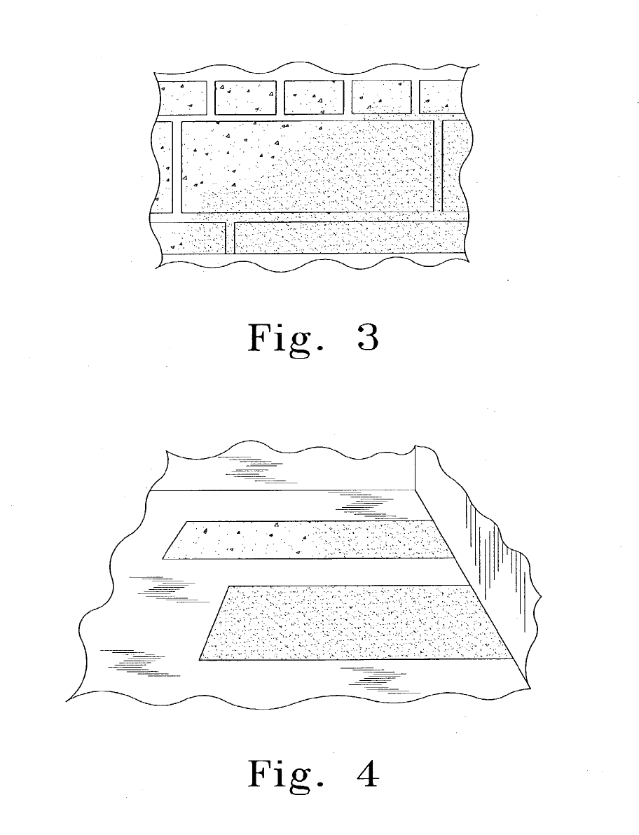

### DETAILED DESCRIPTION OF THE PREFERRED EMBODIMENT

For the purposes of promoting an understanding of the principles of the invention and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

### General Composition and Criteria for Maintaining Sprayability

The present invention relates to a sprayable phosphate cement material with a controlled curing reaction time and viscosity. The cement composition includes a phosphoric acid component, a metallic alkali or base component, a retarder, and water. The phosphoric acid component and the metallic base component are mixed with water separately to form component slurries (i.e., an acid slurry and a base slurry), and each slurry is maintained separately until the application step. A retarder is added to one or both of the above slurries, typically to the water and prior to adding the phosphate acid and/or metallic base components. The acid and base slurries may each be thought of a first and/or second precursor constituent of the phosphate cement composition. Depending upon the order of usage, either could be the first or second constituent. The application step preferentially involves first coating a desired surface with the phosphoric acid mixture and then with the metallic base slurry. Alternately, the application step may involve first coating the desired surface with the base slurry and then the phosphoric acid solution, or simultaneously spraying the desired surface with the both the phosphoric acid solution and the base slurry from separate sources, wherein the acid and base components mix in transit or in situ on the desired surface.

Preferentially metallic base and one or more retardants are added to cold water and mixed in with the silica source(s) to form a slurry. Next, the liquid phosphoric acid or phosphate salts are quickly mixed into the slurry, and the slurry is then preferably immediately sprayed onto a desired target, although the use of cold precursors and strong retarders can extend the shelf-life of the mixed phosphate cement slurry such that immediate spraying is not a requirement. Alternately, with the use of strong retardant additives, dry powder phosphate salts, silica sources, and metallic oxide alkali powders can be mixed together to form a slurry having a long enough shelf-life to make spraying possible.

After the phosphoric acid and the metallic base components are mixed, the phosphate cement slurry is preferably used promptly. The individual cement components may be mixed in spray cans or any clean containers and mixed right on the job, preferably in a cool environment. Preferably, the water used in the mixture is added cold in order to retard the progression of the exothermic acid-base phosphate cement-forming reaction.

Alternately, the phosphoric acid and/or the base coat may be brushed on, with the other coat also either sprayed or brushed on. One coat of the slurry with acid and base and silica sources is usually enough to provide good coverage, although subsequent coats are easy to apply and may be applied immediately after the first coat is applied. This material may also be rolled on. When applying subsequent coats, there is no requisite wait time for drying between coats, even on vertical walls. This cement maybe sprayed overhead.

In the preferred embodiment, the phosphoric acid coating is applied first. More preferably, the phosphoric acid coat contains a silica source admixed therein.

Alternatively, the base coating is applied, preferably by spraying, such that it penetrates the existing phosphoric acid layer and allows the cementitious reaction to begin.

The reaction progresses rapidly since the reactants are spread as a thin coating over a large surface area. Also, the heat generated by the reaction is dissipated quickly, again because the reaction occurs over a large area and is generated in a thinly spread film having a very high surface area to volume ratio.

In an alternate embodiment, the base coat is applied first, followed by the phosphoric acid coat, thereby catalyzing the in-place base slurry.

Some preferred phosphoric acid components include potassium phosphate, magnesium phosphate, sodium phosphate, aluminum phosphate, ammonium phosphate, iron phosphate, zinc phosphate and combinations thereof. By using controlled combinations of different phosphate salts, each one spiking in temperature at a different time, the overall temperature profile of the composition is controlled so as to substantially minimize the maximum temperature reached. Therefore, the controlled combination of the above-listed phosphate salts has the same effect as the addition of a temperature retarder. In addition the resultant mix of different shaped and size crystals can yield denser packing and gives a “granite effect” to a composition formed therefrom, whereby the composition has improved fracture strength as cracks cannot as easily propagate through a composition with no common cleavage lines.

The phosphoric acid component may be either a solid (preferably a powder) or a liquid. Some preferred metallic base components include magnesium oxide, dolomite, zinc oxide, aluminum oxide, potash, calcium oxide, lithium carbonate, barium carbonate, molybdenum oxide, calcium hydroxide, aluminum hydroxide, tin oxide, nickel oxide, magnesium hydroxide, iron oxide, titanium oxide, dolomite, manganese oxide, zirconium oxide, zirconium hydroxide, and wood ash.

One means of controlling the reaction rate of the cement is by controlling the temperatures of the cement components. The colder one or both of the components are kept, the slower the reaction progresses. One way of controlling the temperature of the phosphoric acid component and the metallic base component is by cooling the water used in the admixture of each. Another means of temperature control is cooling one or both of the components' containers and/or the spraying apparatus, such is in an ice bath or by refrigeration. Another means of controlling the reaction rate is to keep the surface to be sprayed cold, such as with ice or cold water or dry ice. Various combinations of these cooling techniques may be employed to obtain maximum temperature control of the reaction.

Another means of controlling the reaction rate is the use of the retarders in the cement-forming components. Preferably, the retarders are added to the water before it is added to the powdered phosphoric acid solution and/or the metallic base precursors (minerals, metal oxides, and the like) to form the base slurry. This approach provides that no water contacts the component materials (usually powders) without a dispersant/retarder present. Since cement-forming powders are reactive, the retarders slow the setting time by keeping them apart, eliminating or reducing rapid agglomeration and aiding to control the reaction of the cement. The retarders may also slow the reaction down by providing a cooling effect.

One preferred retarder is a relatively volatile, water soluble organic solvent, such as alcohol (methanol, ethanol, isopropanol, or the like), acetone, or the like. In one example, isopropyl alcohol is added in sufficient quantity (typically in a 1:3 alcohol to water ratio, although ratios from 1:20 to 1:1 may be selected) to slow the acid-base reaction. The organic solvent is typically added to the water component prior to mixing with the cementitious components. It is thought that the organic solvent slows the reaction kinetics and/or provides an evaporative cooling effect and/or prevents early agglomeration of cementitious particles, so as to facilitate self-consolidation (easy placement into the forms) and self-leveling, yielding the additional benefit of little or no need to “finish”. Organic solvents, typically alcohol, may be added in amounts from 10-95 volume percent, more typically from 20-90 volume percent, still more typically from 30-75 volume percent, and still more typically at about 35-50 volume percent. With dry mix, from about ⅛ to about 2 teaspoons of alcohol may be added for every 10 grams dry mix. Further, alcohol may be applied directly to the substrate prior to spraying the phosphate cement materials thereonto.

Another embodiment of the present invention contemplates pre-mixing the phosphoric acid solution and the metallic base slurry before spraying. In this embodiment, it becomes necessary to reduce the reaction rate of the cement sufficiently to keep the mixed cement slurry from becoming too viscous to remain sprayable as a thin coating. This is achieved through cooling the mixed solution, by using chilled water and/or refrigeration of the container and sprayer and/or through the use of retarders. As above, retarders are used to keep the component particles dispersed in order to slow the chemical reaction and prevent agglomerations from forming inside the sprayer. Another method of controlling the speed of the phosphate cement-forming reaction is through the use of pH buffers to regulate the pH of the solution and thereby its reaction rate. Yet another means of regulating the reaction rate is by controlling the concentration of the acid and base components or, conversely, the water component. Increasing the water concentration will slow the reaction rate of the cement. Traditionally phosphate cement manufacturers want a low water/cement ratio as they believe that like Portland cement, the lower the w/c ratio the greater the compressive strength. Through the addition of more mix water, the crystals continue to grow/form as long as there is unreacted acid and base present, the extra water facilitating exchange of unreacted acid and base ions for continued hardening and pore filling.

It is preferred that the phosphate cement be mixed thoroughly. If an even stronger and less porous cement is desired, it is more preferred that a plastic resin and/or catalyst/initiator be admixed therein to yield a strong phosphate cement that is less porous and more water resistant. The additions of MMA (methyl methacrylate), EMA (ethyl methacrylate), BMA (butyl methyl methacrylate) and other epoxies, urethanes and plastics can also yield harder or tougher cements. Moreover, the addition of an emulsifier helps to better disperse the above additives in the cementitious mixture. Phosphate cements cure exothermically, generating substantial amounts of heat quickly. The heat generated by the curing phosphate cement likewise speeds the curing of endothermic plastics and plastic coatings, such as 2 part epoxies. Additionally, the heat generated by the curing phosphate cements is often sufficient to raise the energy of a system containing an exothermically curing component enough to initiate the reaction (in other words, if the system includes a component that requires an predetermined energy influx in order to begin reacting, the heat spike produced by the curing phosphate cement usually exceeds the predetermined energy influx requirement). The generation of heat is offset by the evolution of the organic solvent, which uses the generated heat to increase its evaporation rate, and thus keeps the temperature of the solution low until the solvent has left the system.

It is preferred that the sprayed surface first be cleaned in order to optimize the bonding of the reactive phosphate cement. It is not necessary to abrade or acid etch a surface in preparation for cement spraying, although a wash with phosphoric acid (or other acids) or NaOH or KOH solutions does tend to enhance bonding. Other cementitious or plastic based products for overlaying concrete require that the concrete surface first be cleaned and then either etched or abraded. Phosphate cements chemically bond very well to hardened and old phosphate cements and Portland cements. Portland cements typically do not bond well to hardened Portland Cements, which is why most pot holes are patched with asphalt.

The reactive phosphate cement mixture bonds to metallic surfaces, such as iron, copper, and steel, even in smooth, sheet metal form. Further, two metallic substrates may be bonded together by a sprayed or otherwise applied phosphate cement layer. Typically, the acidic coat is sprayed onto the metallic substrate first, followed by the alkaline coat. The acidic coating begins to react with the metallic substrate, which enhances the bonding of the cement formed by the application of the alkaline layer thereto. This ‘pre-reacting’ of the metallic surface in effect gives rise to a ‘bonding layer’ formed at the metal-cement interface. Alternately, the phosphoric acid may be applied by dipping, coating, brushing or the like. Further, the application of phosphoric acid may be left on for extended periods of time to ensure complete reaction, and the time between applicastion of the phosphoric acid and the metal oxide may be minutes, hours, days or even longer.

Specifically, an intermediate metal phosphate bond may be formed between a reactive, typically ferrous, metal and a phosphate cement, wherein the bond is situated between a metal (typically ferrous) layer and the later formed phosphate cement metal layer. The intermediate metal (ferric) phosphate bond layer is typically about 200 microns thick, although it may have other thicknesses, and joins the phosphate cement and ferrous layers. The ferrous layer is typically iron or steel, while the metal layer may be a reactive non-ferrous metal, such as copper, brass, or the like. The ferric phosphate bond layer is typically substantially FePO₄.

Typically, the lower the pH of the acid treatment, the better the bonding of the phosphate cement to the metallic substrate. Also, bonding may be enhanced by a physical roughening at the substrate surface. Further, the surface may be pre-etched, such as by application of phosphoric mixture, hydrochloric or like acids, prior to application of the first cementitious component layer, to enhance bonding thereto.

Further, the phosphate acid coating may be applied directly to rusted metallic substrates, since the phosphoric acid will quickly dissolve iron oxide, while substantially more slowly etching the metallic iron. Once sufficient time has elapsed to dissolve the oxide, the metallic-alkaline coating may be applied to react with the phosphoric acid coating to form the cementitious coating.

Some Preferred Phosphate Cement Compositions

In one preferred embodiment, the phosphate cement composition is comprised of a non-aqueous portion and an aqueous portion with an organic solvent retarder added to one or both. The non-aqueous portion comprises about 85% silica or other aggregate and about 15% cement paste (by wt.); wherein the cement paste consists of an acid component, a base component, and additives (mostly dispersants and retarders). One preferred retarder additive is isopropyl. The base component includes calcined MgO, and the acid component includes equal amounts of mono potassium phosphate (MKP) and mono magnesium phosphate (MMP). The aqueous portion is at least about 50% by weight of the cement paste. The silica/aggregate component is preferably about 13% silica flour, about 80% class “C” or class “F” fly ash, about 7% sodium and/or potassium silicate and about 10% methyl silicate and/or colloidal silica and/or fumed silica and/or silica fume and/or anhydrous silica. Using the Schutz automotive undercoating spray gun or another medium-to-large orifice gun (such as a sand-blasting gun), fine crushed gravel can be mixed in to achieve a sprayed concrete of any type, including Portland cement. Phosphate cements can also be sprayed through traditional large-scale shotcreting equipment with the additions of appropriate retarding and/or lubricating admixtures, as detailed hereinbelow.

The cement compositions may be tailored to the desired end use. For example, it is possible to activate the silica sources by treating them with about 2-5% NaOH or KOH solution or with a solution of about 2-10% phosphoric acid to increase their reactivity. Likewise, it is possible to use potassium and/or sodium silicate, in either liquid or powder form, to replace or supplement some of the other silica sources and to fill in pores. Replacing high calcined MgO with low calcined dolomite, MgO or CaO as the base increases coating strength and reactivity. Alternately, a mixture of calcined MgO and dolomite may be used with liquid phosphoric acid or phosphate salts as the cement precursors, with total acid and base combined concentrations ranging from about 5%-60% of the total cement mixture, more preferably about 20%. Decreased acid-base concentrations mean increased water concentrations, which yields better “wetting” and slower drying, giving the acid more time to react completely with as much base as possible, resulting in an enhanced hardness with time. Using sawdust, agar, Berylex™, or celluosic fibers increases the amount of water inside the matrix, yielding a slower and longer and more complete reaction which typically results in harder and/or less porous materials.

It is also possible to partially or completely replace MgO with natural wood ashes, such as wood potash, as the base component. The use of wood ash resulted in a smooth cement finish and a very hard coating. The reaction rate is slowed by replacing part or all of the MgO with slower reacting bases such as dead-burned MgO or with ZnO, Al2O3, Fe2O3, TiO2, ZrO, ZrOH or Fe3O4.

Adding adhesive admixtures or mixtures of mono sodium phosphate (MSP) and aluminum phosphate yields a cement having enhanced adhesion, as does the addition of chlorinated polyolefin. The advantages of increased adhesion include greatly reduced rebound upon spraying and less running and dripping on vertical walls and/or ceilings. These adhesive phosphate cements make excellent mortars. For spraying overhead or vertical walls, more adhesiveness is desirable and MSP, or MSP and aluminum phosphates may be combined to replace up to 20% of the primary phosphate component of the cement.

The following admixtures, aggregates, have been found to improve or modify the properties of the phosphate cements, phosphate cements being acid-base reactive ceramic cements wherein the acid is phosphoric acid (either liquid or as a phosphate salt, usually an alkali-earth salt such as a phosphate of magnesium, calcium, sodium, aluminum, zinc, or the like or ammonia) along with a base that is usually calcined magnesium oxide, dolomite, calcium oxide or the like, although it can contain other aggregates, such as sand and/or stone. The characteristics of the resultant cementitious product, such as a coating, may be tailored through the use of one or more additives or other ingredients. For example, replacing some of the phosphoric acid/salt with nitric acid results in a modified binder system. Lithium, zirconium, and aluminum oxides are especially useful where the composite will be subject to high temperatures.

Hardness and the hardening rate of the phosphate cement coatings may be impacted by the addition of Ca, Na, or Mg fluorosilicates, multiple-phosphate salts, calcium fluoride, glass frit, zirconium hydroxide, sodium permanganate, potassium permanganate, sodium aluminate, sodium silicate, potassium silicate, silica dust, plastics, zirconium, iron and aluminum oxides, and colostrum. The replacement of magnesium phosphate with calcium phosphates instead of magnesium or potassium or using them along with Al, Mg, K, Ca Na, or Zn phosphates and sufficient water allows cementitious reactions to progress even after the cement sets up, i.e. the cement increases in hardness with time so long as there is internal moisture to drive the reaction. Alternatively, hard materials such as diamond, silicon carbide, boron nitride, tungsten carbide, molybdenum metal and/or oxide, and the like may be added into the mix to provide an additional composite or quasi-composite phase. Ultrafine particles of fly ash, silicon boride, silicon carbide, boron carbide, aluminum nitride, aluminum oxide, and hard metals in the cement matrix also have the effect of increasing the hardness of the resultant cement body or coating. These particles are preferably spherical and may also be pretreated with KOH or NaOH (or nitric, phosphoric or hydrochloric acids or combinations of these acids) to increase their effectiveness.

Other additives that increase the hardness of the phosphate cement compositions include: oxides of aluminum, manganese, molybdenum, nickel, chromium and vanadium, aluminum paste, zinc-aluminum paste, tin, colostrum, iron ore concentrate or iron oxides alone or in combination with aluminum. Also, solvents added to the slurry or spread on the hardened cements of above compositions can be ignited to rapidly cure and density the composites. These composites can be made in-situ, resulting in very hard net-shape products. These phosphate cements can be added integrally to ordinary Portland cement materials.

The process of spraying concrete may also act to increase its density. The density of sprayed phosphate cements may also be influenced by such factors as the particle size distribution, or PSD, of the component materials, temperature of the mix and surfaces, the reactivity of the mix, and the amount of air mixed into the spray jet.

The use of chemical retarders to regulate the reaction rate is important. The use of retarders, along with maintaining smaller particle sizes of the components and maintaining a low temperature cement system, is important in making cements sprayable. However, smaller particle size means more surface area and faster reaction, setting and hardening. Reaction rate may therefore be controlled through variations of the PSDs of the precursors. Further, precise temperature control is not always feasible, especially regarding large scale construction projects and applications subject to temperature extremes, such as from the weather. Thus, the use of retarders, alone or with particle size reduction and/or temperature control, is the preferred means of controlling the reaction rate of the phosphate cement coatings. Accelerators are useful in very cold weather; the present material can be sprayed down to 20 degrees Fahrenheit.

Using the above described retarders and retardation techniques, phosphate cement slurries may produced that can be sprayed, troweled, dipped, brushed, flowed, vibrated, stirred or otherwise placed; the slurries so produced tend to be self-leveling and can be self-filled into forms.

The following is a brief list of some of the advantages and applications of phosphate cements:
High strength, exceeding the strength of conventional Portland cement or Portland cement concrete;
Strength is typically about 2500 psi (pounds of compression strength) within an hour, about 7000 psi within 24 hours, about 10,000 psi within a week, 11,000 psi in about 28 days; this is without any additives or admixtures. In contrast, Portland cement concrete usually exhibits a strength of only 3000-5500 psi after 28 days and it cannot be driven on for several days;
Can patch a road or flatwork in 20 minutes and drive cars on it in 1 hour and semi-tractor trailers in 1.5 hours. Can spray a new surface on roads and other Portland cement/concrete surfaces;
Can place patches in roads in 5 minutes and then immediately or anytime later can coat an entire new surface; no new road bed is required. Efficiency includes using preexisting old road and road bed as a pre-compacted and level road bed with a crown center already built in;
Adheres to itself and also to Portland cement (Portland cement adheres poorly to itself, which is why Portland cement roads are rarely patched with Portland cement absent extensive cleaning, drilling, placement of rebar, and the like).
As a ceramic phosphate cement is resistant to heat (can take in excess of 3000 degrees Fahrenheit), mold, mildew, water, UV, cold, and flame.
Uses almost all mineral colorants beautifully, colors may be mixed on the job.
Superior thermal insulator.
Superior electrical insulator.
Eliminates or greatly reduces maintenance.
Can be easily mixed on the job with a power hand drill and a mixing blade or in a mortar mixer.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

I claim:

1. A method of producing a phosphate cement mixture, comprising the steps of:
a) providing a surface to be cemented;
b) providing a first cementitious constituent;
c) providing a second cementitious constituent adapted to combine with the first cementitious constituent to produce an aqueous phosphate cement mixture;
d) adding a volatile organic retardant to at least one of the first and second constituents;
e) applying the first cementitious constituent to the surface;
f) applying the second cementitious constituent to the surface;
g) reacting the first and second cementitious constituents to produce a phosphate cement mixture.

2. The method of claim 1 wherein the first constituent is a phosphoric acid and the second constituent is a metallic base.

3. The method of claim 2 wherein the first constituent includes at least one of the following group: potassium phosphate, calcium phosphate, magnesium phosphate, sodium phosphate, aluminum phosphate, zinc phosphate; and wherein the second constituent includes at least one of the following group: magnesium oxide, magnesium hydroxide, calcium hydroxide, zirconium oxide, zirconium hydroxide, potassium hydroxide, sodium hydroxide, dolomite, zinc oxide, aluminum oxide, potash, calcium oxide, lithium carbonate, barium carbonate, molybdenum oxide, aluminum hydroxide, tin oxide, nickel oxide, iron oxide, and titanium oxide.

4. The method of claim 1 wherein the first constituent is a metallic base and the second constituent is a phosphoric acid.

5. The method of claim 4 wherein the first constituent includes at least one of the following group: magnesium oxide, magnesium hydroxide, calcium hydroxide, zirconium oxide, zirconium hydroxide, potassium hydroxide, sodium hydroxide, dolomite, zinc oxide, aluminum oxide, iron oxide, titanium oxide, wood ash; and wherein the second constituent includes at least one of the following: potassium phosphate, magnesium phosphate, zinc phosphate, ammonium phosphate, sodium phosphate, and calcium phosphate.

6. The method of claim 1 wherein the volatile organic retardant is selected from the group including acetone, ethanol, methanol, and isopropanol.

7. The method of claim 1 wherein the steps e) and f) occur substantially simultaneously and wherein the first and second constituents intermix during spraying.

8. The method of claim 1 further comprising the step: after step c) and before step e) h) mixing the first and the second constituents; wherein steps e) and f) occur substantially simultaneously.

9. The method of claim 1 wherein at least one of the constituents is heated.

10. The method of claim 1 wherein at least one of the constituents is cooled.

11. The method of claim 1 wherein the phosphate cement mixture includes about 20 volume percent volatile organic retarder.

12. The method of claim 1 wherein the phosphate cement mixture includes about 35 volume percent volatile organic retarder.

13. The method of claim 1 wherein the phosphate cement mixture includes about 50 volume percent volatile organic retarder.

14. A method of producing a slow-setting, workable aqueous phosphate cement mixture, comprising the steps of:
a) providing a first cementitious constituent;
b) providing a second cementitious constituent adapted to combine with the first cementitious constituent to produce an aqueous phosphate cement mixture;
c) providing a volatile organic retardant; and
d) mixing the first cementitious constituent, the second cementitious constituent, and the volatile organic retardant to yield a slow-setting phosphate cement mixture.

15. The method of claim 14 wherein the volatile organic retardant is selected from the group including acetone, ethanol, methanol, and isopropanol.

16. The method of claim 14 wherein the slow-setting phosphate cement mixture includes between about 35 and about 50 volume percent volatile organic retardant.

17. The method of claim 14 further comprising the step: after step c) and before step d), e) mixing the volatile organic retardant with at least one of the first and the second cementitious constituents.

18. An intermediate bond between a ferrous metal and a phosphate cement, comprising:
a ferrous layer;
a phosphate cement metal layer; and
an intermediate ferric phosphate bond layer about 200 microns thick joining said phosphate cement and ferrous layers.

19. The bond of claim 18 wherein said ferrous layer is steel.

20. The bond of claim 18 wherein said intermediate ferric phosphate bond layer is substantially FePO₄.
